(19) United States
(12) Patent Application Publication
(10) Pub. No.: US 2016/0290042 A1
(43) Pub. Date: Oct. 6, 2016

(54) Nannies Mosquito Garage Netting

(71) Applicant: Lilly Evelyn Clement, Fredericksburg, VA (US)

(72) Inventor: Lilly Evelyn Clement, Fredericksburg, VA (US)

(21) Appl. No.: 14/680,009

(22) Filed: Apr. 6, 2015

(51) Int. Cl. E06B 9/52

(52) U.S. Cl. CPC E06B 9/52; E06B 2009/527

(57) ABSTRACT

Nannies Mosquito Garage Netting is made with Fabric, Netting, Double, Sided Velcro Strips with Ribbons.

No Tools needed to Install or Remove. (In Minutes) Two Panels measuring 4.3 feet across and 7.3 feet Down.

4 Feet Double sided Velcro Strips at the Top of each Panel.

Remove Back Velcro Strips and attach Top pieces to Top of the Garage opening.

(6) Ribbons to connect the Middle pieces, and then (3) on each side to connect the Garage rails.

To remove untie Ribbons, Peel fabric from Velcro Strip attached to the Garage.

Nannies Mosquito Garage Netting can and do Prevent Flying insects from entering The Garage door While displayed.

This will allow Garage Owners to use their Garages, Day or Night and not be concerned with Flying Insects.

This Design is for Garages measuring (8) feet across and (7) feet down

### DESIGN MATERIALS

Design calls for (1) Car Garages (2) Panels
(2) Nylon Netting Panels Measuring in Size 4.3 feet across and 7.3 feet down for (1) Car garage.
Borders measuring at (3) inches across the Top, Bottom and Sides on each Panel.
(4) Strips of Borders for Top and Bottom of the (2) Each Panels measuring at 4.3 across
(4) Strips of Borders for sides of the (2) Each Panel measuring at 7.3 down
(2) Double Sided Velcro Strips measuring at (1) to (2) inches across the Top of each panel.
(6) Ribbons per Panel (6) ties to garage railings (3) each side

### Match

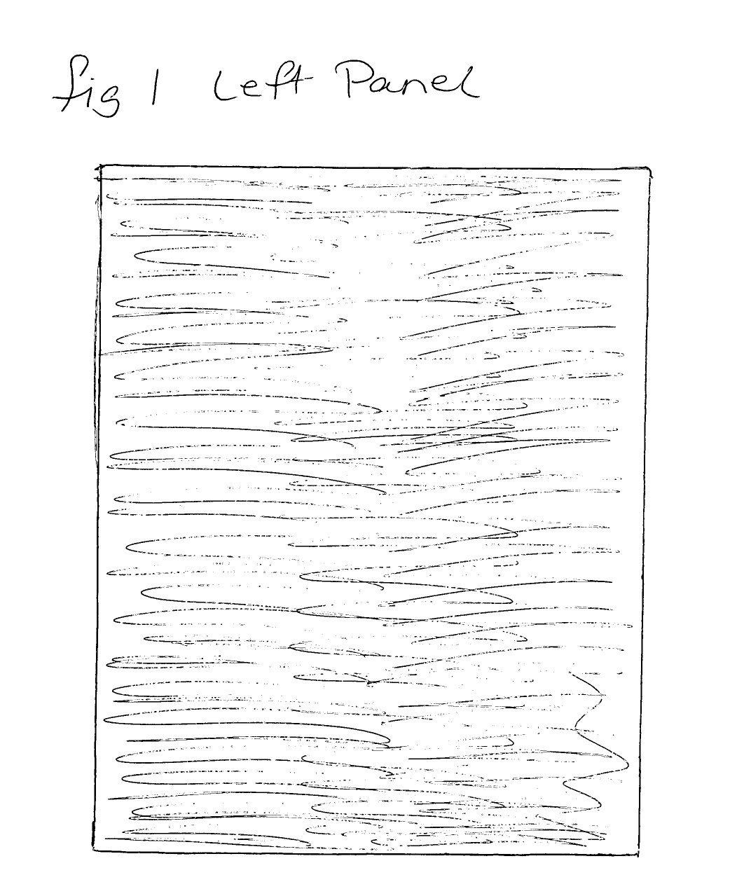

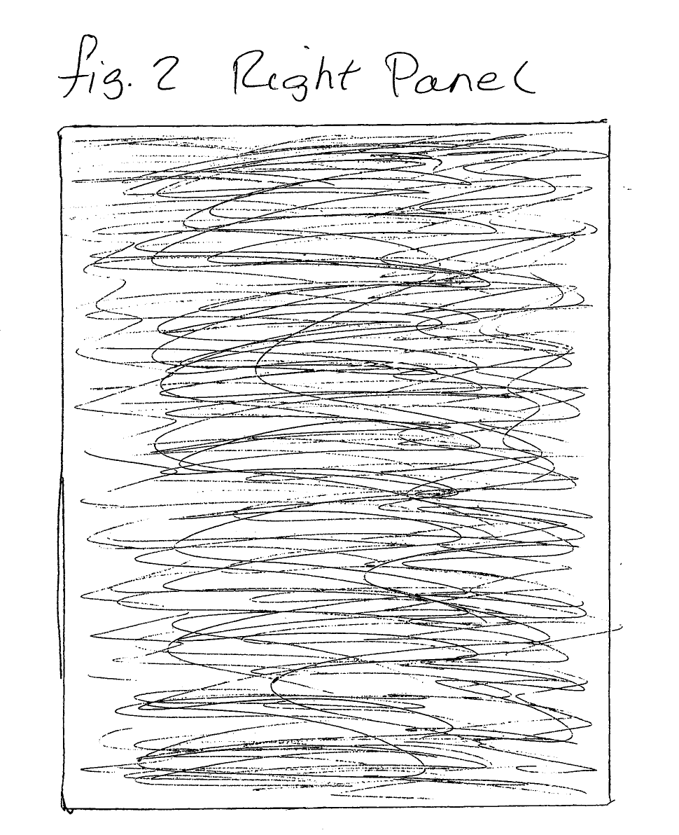

### FIG. 1 Left Panel to, FIG. 2 Right Panel

### Measure Starting at the Top of Garage Each Panel

4′.3″ Across Top then 7′.3″ in Length down. Allowing Panel to flow.

### FIG. 1 and FIG. 2

Remove Strip from top of Panel to install inside the top of the Garage Opening.
Apply pressure to top of Panel to make sure that the double sided Velcro strip Are, holding to the garage and Panel.
   Next: Tie the middle Ribbons together, and then the Garage Rail Ribbons.

In minutes sit back and enjoy your Space. Flying insects FREE

### FIG. 1 Left Panel

### 4′.3″ Across Top of Panel

### 7′.3″ Down Length of Panel

3 Double Ribbons left side of FIG. 1
3 Single Ribbons connecting the middle of FIG. 1

### FIG. 2 Right Panel

### 4′.3″ Across top of Panel

### 7′.3″ Down Length of Panel

3 Double Ribbons right side FIG. 2
3 Single Ribbons connecting middle of FIG. 1 and FIG. 2
1 Inch Diameter Double sided Velcro Strips

### Attached to top of FIG. 1 and FIG. 2

Double Ribbon Sides attaches to Garage Rails
Single ribbons ties FIG. 1 and FIG. 2 together

### DESCRIPTION OF FIGS. 1-8

FIG. 1 is left panel and FIG. 2 is right panel measuring 4.3 feet width and 7.3 feet length

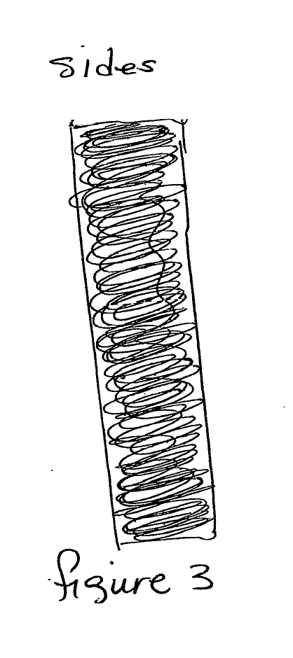

FIG. 3 are the side borders of each panel that attaches to FIG. 1 and FIG. 2

Measuring at 2 inches in width and 7.3 feet in length

FIG. 4 is the top border of each panel FIG. 1 and FIG. 2.

Measuring 2 inches in width and 4.3 in length

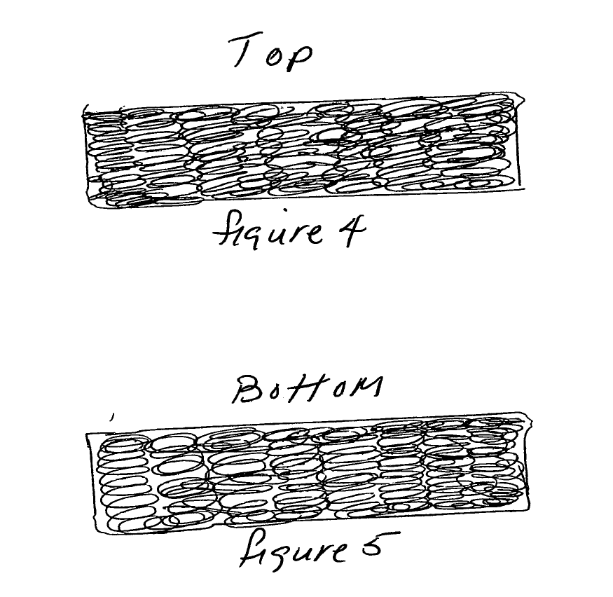

FIG. 5 is the bottom border of each panel FIG. 1 and FIG. 2

Measuring 2 inches in width and 4.3 length

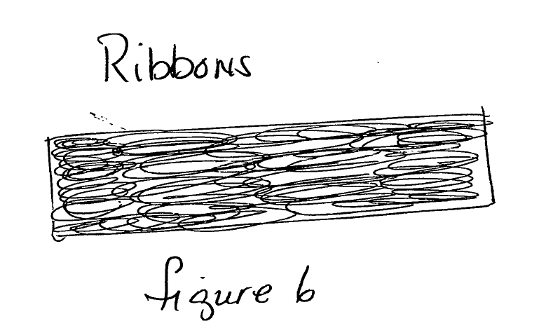

FIG. 6 are the Ribbons used to tie panels together and to garage door rails.

Measuring 5 inches in length

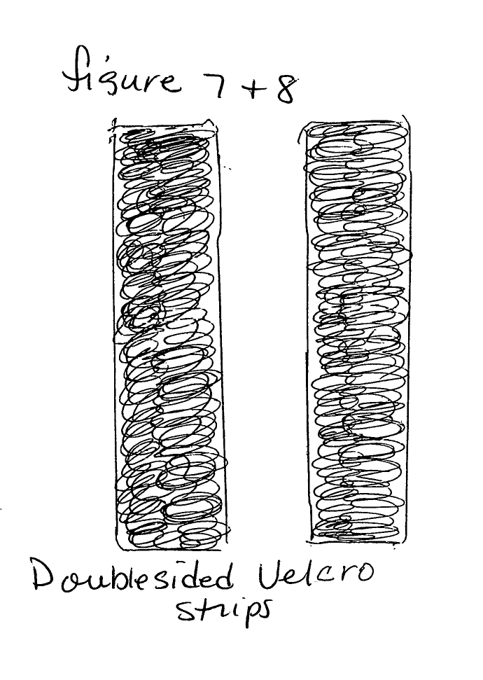

FIG. 7 and FIG. 8 are double sided Velcro strips that is at the top of FIG. 1 and FIG. 2

Measuring 1 inch in width and each strip cut to 4.3 in length

Clean area before installing. Place Panels above garage door opening. Removing strip from Velcro to adhere to garage from top of FIG. 1 and FIG. 2.

Tie down FIG. 6 to the sides of garage rail left and right panels.

Next tie FIGS. 1 and 2 together with remaining FIG. 6

### SUMMARY

Nannies Mosquito Garage Netting is made with Fabric, Netting, Double sided Velcro Strips with Ribbons.

No Tools needed to Install or Remove. Two Panels Measuring 4.3 feet across and 7.3 feet down (4) feet Double sided Velcro Strips at the Top of each Panel.

Remove Velcro Strips and attach top pieces to the top of the garage opening.

Six Ribbons to connect the middle pieces.

Three on each side to connect to the Garage Rails.

To Remove untie Ribbons, then just Peel Fabric from Velcro strips attached To the Garage. Leaving back Velcro strip attached to the Garage.

It can be left hanging with Garage door closed and Ribbons untied.

Nannies Mosquito Garage Netting can and do prevent Flying insects from Entering the Garage door while displayed openly.

This will allow Garage Owners to Use their Garages Day or Night and not be Concerned with Flying Insects.

This Design is for Garage openings measuring 8 feet across and 7 feet down

1. Nannies Mosquito Garage Netting, Is different because there are no Tools Needed To Install or Remove. It comes ready to Install in Minutes or Removes in Minutes. It will prevent flying insects from flying right into your Garage Space. Garage Door can be closed also while displayed, just untie the Ribbons. We enjoy the garage space at night when the Mosquitos and other Flying insects is out. We also make the garage designated Smoking Area for when Smokers Visit and it is too Hot outside or a Smoke free home.
